(19) United States
(12) Patent Application Publication
(10) Pub. No.: US 2025/0277926 A1
(43) Pub. Date: Sep. 4, 2025

(54) TERMINAL BLOCK AND I/O UNIT

(71) Applicants: FANUC CORPORATION, Yamanashi (JP); WEIDMUELLER INTERFACE GMBH & CO. KG, Detmold (DE)

(72) Inventors: Masahiro SAEKI, Yamanashi-ken (JP); Shinichi KUWAHATA, Yamanashi-ken (JP); Jens OESTERHAUS, Detmold (DE); Jan MEIER, Detmold (DE); Ralf SCHUMACHER, Lemgo (DE); Klaus PUESCHNER, Detmold (DE); Torsten DIEKMANN, Leopoldshoehe (DE)

(21) Appl. No.: 18/858,671

(22) PCT Filed: Apr. 28, 2022
(86) PCT No.: PCT/JP2022/019312

§ 371 Date: Oct. 21, 2024

(51) Int. Cl. F21V 8/00

(52) U.S. Cl. CPC G02B 6/0006

(57) ABSTRACT

A terminal block includes a plurality of insertion sections each provided with a connection terminal that is electrically connected to an external terminal; a plurality of lighting sections provided corresponding to the plurality of insertion sections; a plurality of light guide members that are provided corresponding to the plurality of lighting sections and that direct light emitted by a plurality of light emitting elements to the plurality of lighting sections to cause the plurality of lighting sections to light; and at least one connecting member connecting the plurality of light guide members.

### TECHNICAL FIELD

The present invention relates to a terminal block, and an I/O unit including the terminal block.

### BACKGROUND ART

JP 2001-125607 A discloses an example of an I/O unit (signal transmission device). The signal transmission device includes a display unit. The display unit includes a light emitting diode (LED) that is turned on. The display unit (lighting unit) is disposed on the front surface of the signal transmission device.

### SUMMARY OF THE INVENTION

One of the parts that form the lighting unit of the I/O unit is a light guide member that guides light emitted by the light source. The light guide member is, for example, a light pipe.

The I/O unit may include a plurality of lighting units. In this case, a plurality of light guide members are provided in the I/O unit in accordance with the number of the lighting units. However, as the number of the light guide members provided in the I/O unit increases, it takes more time to assemble the light guide members to the I/O unit.

The present invention has the object of solving the aforementioned problem.

According to a first aspect of the present invention, there is provided a terminal block comprising: a plurality of insertion-receiving portions into which a plurality of external terminals are inserted, respectively, and which are provided respectively with connection terminals each electrically connected to a corresponding one of the inserted external terminals; a plurality of lighting portions provided corresponding to the plurality of insertion-receiving portions, respectively; a plurality of light guide members provided corresponding to the plurality of lighting portions, respectively, and each configured to light a corresponding one of the plurality of lighting portions by guiding, to the corresponding one of the plurality of lighting portions, light emitted by a corresponding one of a plurality of light emitting elements; and at least one coupling member coupling the plurality of light guide members.

According to a second aspect of the present invention, there is provided an I/O unit comprising: the terminal block according to the first aspect; the plurality of light emitting elements; and a communication processing circuit configured to control input/output of signals to/from the plurality of external terminals connected to the terminal block, and control light emission of the plurality of light emitting elements.

According to the present invention, an increase in the operating time for assembling the light guide members to the terminal block of the I/O unit is suppressed.

### BRIEF DESCRIPTION OF DRAWINGS

FIG. 1 is a diagram showing a communication system according to a reference example;

FIG. 2 is a perspective view showing a front portion and a left side portion of an I/O unit according to the reference example;

FIG. 3 is a diagram for explaining the internal configuration of a connector unit according to the reference example;

FIG. 4A is a perspective view showing a front portion and a left side portion of an I/O unit according to an embodiment, and FIG. 4B is an exploded view of the I/O unit of FIG. 4A;

FIG. 5 is a diagram for explaining the internal configuration of a connector unit according to the embodiment;

FIG. 6A is a diagram showing a connector unit according to a first modification, and FIG. 6B is a diagram showing another connector unit according to the first modification; and

FIG. 7 is a diagram showing a connector unit according to a second modification.

### DETAILED DESCRIPTION OF THE INVENTION

### Embodiment

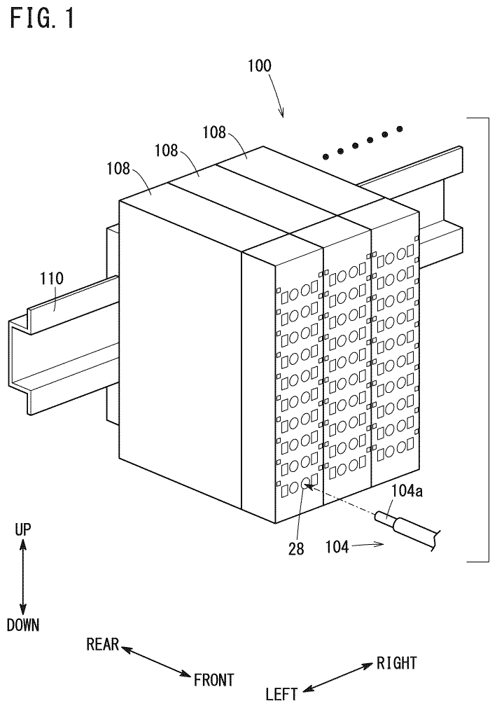

FIG. 1 is a diagram showing a communication system 100 according to a reference example.

Note that a plurality of arrows shown in each drawing indicate respective directions (front, rear, left, right, up, and down) used in the following description. An up-down direction (a first direction), a left-right direction (a second direction), and a front-rear direction are orthogonal to each other. The left-right direction and the front-rear direction are parallel to a horizontal plane, for example.

The communication system 100 is a system for transmitting signals between a controller and a device 104. The controller is, for example, a numerical controller that controls a machine tool. The device 104 is, for example, an actuator, a detector, or the like provided in the machine tool. The controller is not shown in the drawing. FIG. 1 shows only a part including an external terminal 104a of the device 104.

The communication system 100 includes a plurality of I/O units (input/output units) 108. The plurality of I/O units 108 are consecutively arranged on a predetermined installation member 110. The number of the I/O units 108 to be consecutively arranged is not particularly limited.

The installation member 110 is, for example, a DIN rail. The extending direction of the installation member 110 illustrated in FIG. 1 is the left-right direction. That is, the installation member 110 illustrated in FIG. 1 is long in the left-right direction.

The plurality of I/O units 108 are attached to the front portion of the installation member 110. In the illustration of FIG. 1, the arrangement direction of the plurality of I/O units 108 coincides with the extending direction of the installation member 110.

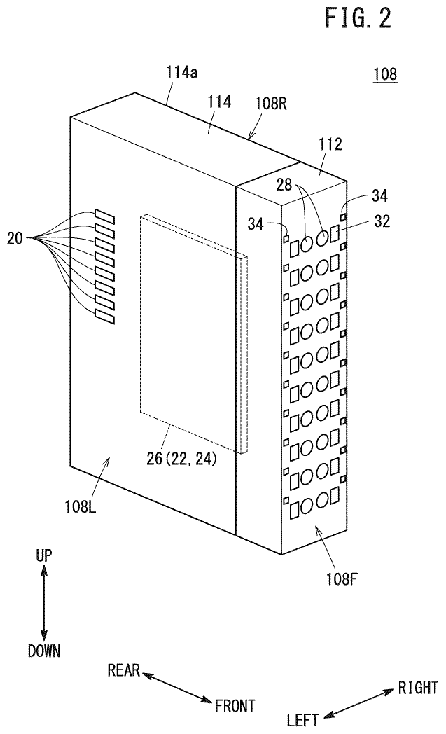

FIG. 2 is a perspective view showing a front portion 108F and a left side portion 108L of the I/O unit 108 according to the reference example.

The I/O unit 108 includes a connector unit 112 and a communication processing unit 114.

The communication processing unit 114 includes a housing 114a, a plurality of contactors 20, and a control module 26. The housing 114a accommodates the plurality of contactors 20 and the control module 26. However, a part of each contactor 20 is exposed to the outside at the left side portion 108L or a right side portion 108R of the I/O unit 108.

The plurality of contactors 20 are a terminal group electrically connected to another I/O unit 108 adjacent to the I/O unit 108.

The plurality of contactors 20 are arranged on each of the left side portion 108L and the right side portion 108R. The plurality of contactors 20 on the right side portion 108R are arranged symmetrically with the plurality of contactors 20 on the left side portion 108L, for example. All of the contactors 20 are electrically connected to the control module 26.

The control module 26 is a module including a communication processing circuit 22 and a plurality of light emitting elements 24.

The communication processing circuit 22 is an electric circuit that performs processing necessary for establishing communication between the controller and the device 104. The communication processing circuit 22 includes, for example, a control integrated circuit (IC). The communication processing circuit 22 is mounted on, for example, a resin board.

The communication processing circuit 22 is electrically connected to the plurality of contactors 20. In this case, the communication processing circuit 22 is electrically connected to another unit disposed on the left side of the I/O unit 108 via the plurality of contactors 20 disposed on the left side portion 108L. Further, the communication processing circuit 22 is electrically connected to another unit disposed on the right side of the I/O unit 108 via the plurality of contactors 20 disposed on the right side portion 108R.

The communication processing circuit 22 is connected to a plurality of the devices 104 via the connector unit 112. Therefore, in FIG. 1, the device 104 is electrically connected to the controller via at least one I/O unit 108. The controller and the device 104 can input and output signals via at least one communication processing circuit 22. The connector unit 112 will be described in more detail later.

The plurality of light emitting elements 24 include, for example, a plurality of light emitting diodes (LEDs). Each light emitting element 24 is disposed on a board, for example, in the same manner as the communication processing circuit 22. Each light emitting element 24 can emit light under the control of the communication processing circuit 22. The plurality of light emitting elements 24 are provided corresponding to a plurality of lighting portions 34 provided on the connector unit 112.

The connector unit 112 is a terminal block device for connecting the external terminal 104a (see FIG. 1) of the device 104. The connector unit 112 includes the front portion 108F of the I/O unit 108. That is, the connector unit 112 is disposed forward of the communication processing unit 114. The connector unit 112 includes a plurality of insertion-receiving portions 28, a plurality of release operating elements 32, and the plurality of lighting portions 34.

Each of the plurality of insertion-receiving portions 28 is a portion to which the external terminal 104a is connected. Each of the insertion-receiving portions 28 includes, for example, an insertion opening into which the external terminal 104a is inserted. The plurality of insertion-receiving portions 28 are provided in the front portion 108F.

The plurality of release operating elements 32 are an operating element group provided corresponding to the plurality of insertion-receiving portions 28. Each of the plurality of release operating elements 32 is, for example, a pusher. In response to an operation of an operator, each of the release operating elements 32 releases the connection between the corresponding insertion-receiving portion 28 and the external terminal 104a connected to that insertion-receiving portion 28.

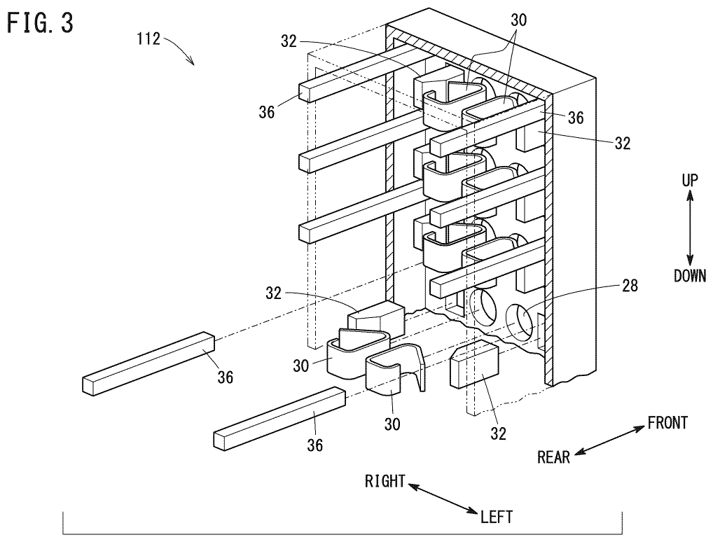

The plurality of release operating elements 32 are disposed on the inner side of the connector unit 112 (see also FIG. 3). However, at least a part of each release operating element 32 is exposed to the outside so that the operator can operate the release operating element 32. For example, a part of each release operating element 32 is exposed to the outside at the front portion 108F.

The plurality of lighting portions 34 are provided corresponding to the plurality of insertion-receiving portions 28, respectively. The plurality of lighting portions 34 are disposed at, for example, the front portion 108F. Each lighting portion 34 includes a member that transmits light. For example, each lighting portion 34 includes a transparent member or a translucent member.

FIG. 3 is a diagram for explaining the internal configuration of the connector unit 112 according to the reference example.

The connector unit 112 further includes a plurality of connection terminals 30 and a plurality of light guide members 36.

The plurality of connection terminals 30 are arranged corresponding to the plurality of insertion-receiving portions 28, respectively. Each connection terminal 30 has conductivity. The plurality of connection terminals 30 are disposed on the inner side of the connector unit 112. However, each connection terminal 30 can be brought into contact with the external terminal 104a via the corresponding insertion-receiving portion 28. By coming into contact with the external terminal 104a inserted into the corresponding insertion-receiving portion 28, each connection terminal 30 is electrically connected to the external terminal 104a.

The plurality of light guide members 36 are arranged corresponding to the plurality of lighting portions 34. Each light guide member 36 is, for example, a light pipe that is long in the front-rear direction. The plurality of light guide members 36 are disposed on the inner side of the connector unit 112. However, at least a part of each light guide member 36 may extend to the inside of the communication processing unit 114.

Each light guide member 36 transmits light emitted by the corresponding light emitting element 24 to the corresponding lighting portion 34. Consequently, each lighting portion 34 can be lit by using light transmitted from the corresponding light guide member 36.

Incidentally, in the I/O unit 108, as the number of the light guide members 36 provided in the I/O unit 108 increases, it takes more time to assemble the light guide members 36 to the I/O unit 108.

Based on the above, an I/O unit 10 according to an embodiment will be described below. However, explanations overlapping with those of the above-described reference example will be omitted as much as possible in the following description. Elements that have been described in the reference example are denoted by the same reference numerals as in the reference example unless otherwise specified.

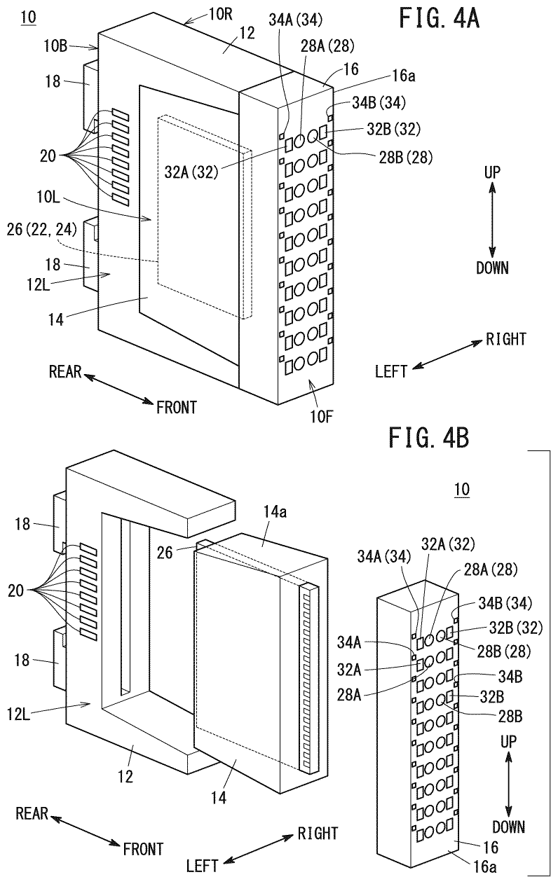

FIG. 4A is a perspective view showing a front portion 10F and a left side portion 10L of the I/O unit 10 according to the embodiment. FIG. 4B is an exploded view of the I/O unit 10 of FIG. 4A. Note that a right side portion 10R of the I/O unit 10 may be substantially symmetrical with the left side portion 10L.

The I/O unit 10 is preferably divisible into a base unit 12, a communication processing unit 14, and a connector unit 16, which will be described below.

The base unit 12 is a part including a rear portion (a rear end portion) 10B of the I/O unit 10. The base unit 12 includes an end engagement portion 18, and a plurality of contactors 20.

The end engagement portion 18 is provided at the rear portion 10B. The end engagement portion 18 is provided to engage with an installation member 110. For example, the end engagement portion 18 includes a claw that engages with a part of the installation member 110. The I/O unit 10 is installed on the installation member 110 by the end engagement portion 18 engaging with the installation member 110.

The plurality of contactors 20 are disposed on each of a left side portion 12L of the base unit 12 and a right side portion of the base unit 12. The right side portion of the base unit 12 is not shown.

Note that the left side portion 12L of the base unit 12 is included in the left side portion 10L of the I/O unit 10. Further, the right side portion of the base unit 12 is included in the right side portion 10R of the I/O unit 10.

A part of each contactor 20 disposed on the left side portion 12L is exposed to the outside of the base unit 12 at the left side portion 12L. Similarly, a part of each contactor 20 disposed on the right side portion of the base unit 12 is exposed to the outside of the base unit 12 at the right side portion.

The communication processing unit 14 is a part that can be attached to and detached from the base unit 12. The communication processing unit 14 is disposed forward of the base unit 12, and is mounted on the base unit 12 toward the rear side.

The communication processing unit 14 includes a housing 14a and a control module 26. The housing 14a accommodates the control module 26. The control module 26 includes a communication processing circuit 22 and a plurality of light emitting elements 24.

The communication processing circuit 22 is electrically connected to the plurality of contactors 20 by the communication processing unit 14 being mounted on the base unit 12. Each light emitting element 24 emits light under the control of the communication processing circuit 22. Each light emitting element 24 includes, for example, an LED.

The connector unit (a terminal block) 16 is a part that can be attached to and detached from the communication processing unit 14. The connector unit 16 is disposed forward of the communication processing unit 14, and is mounted on the communication processing unit 14 toward the rear side. The connector unit 16 includes the front portion 10F of the I/O unit 10.

The connector unit 16 includes a housing 16a, a plurality of insertion-receiving portions 28, a plurality of release operating elements 32, and a plurality of lighting portions 34. The housing 16a may include an engagement mechanism for coupling with the housing 14a of the communication processing unit 14. The plurality of insertion-receiving portions 28, the plurality of release operating elements 32, and the plurality of lighting portions 34 are disposed at, for example, the front portion 10F.

Each of the plurality of insertion-receiving portions 28 is a portion to which a device 104 (see FIG. 1) is connected. Each of the insertion-receiving portions 28 includes, for example, an opening into which an external terminal 104a of the device 104 is inserted. The opening is formed in the front surface of the housing 16a.

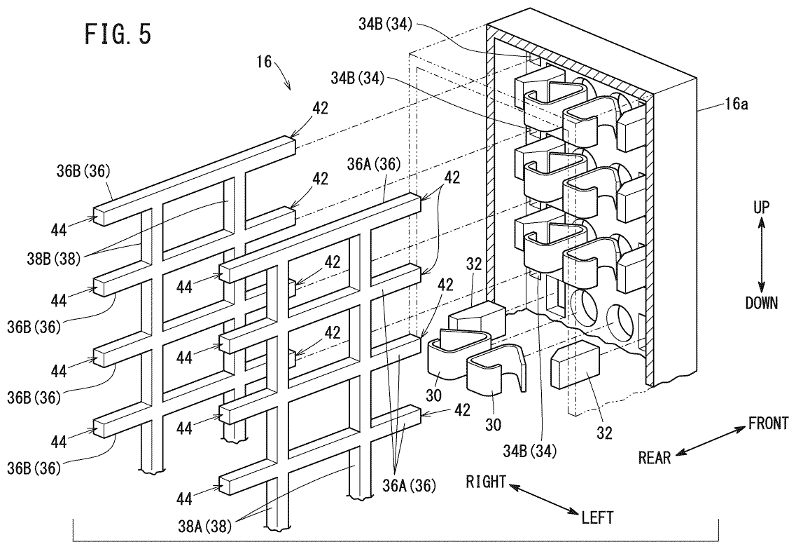

Note that a plurality of connection terminals 30 respectively corresponding to the plurality of insertion-receiving portions 28 are disposed inside the housing 16a (see also FIG. 5). The device 104 is connected to the connection terminal 30 corresponding to the insertion-receiving portion 28 into which the external terminal of the device 104 is inserted.

The plurality of connection terminals 30 are electrically connected to the communication processing circuit 22 by the connector unit 16 being mounted on the communication processing unit 14. Therefore, the device 104 is electrically connected to the communication processing circuit 22 via the connection terminal 30 corresponding to the insertion-receiving portion 28 into which the external terminal of the device 104 is inserted.

The number of the insertion-receiving portions 28 provided in the connector unit 16 is not particularly limited. The plurality of insertion-receiving portions 28 may be arranged in a plurality of rows at the front portion 10F. For example, the plurality of insertion-receiving portions 28 (28A, 28B) illustrated in FIGS. 4A and 4B are arranged in two rows at the front portion 10F. In each row, the plurality of insertion-receiving portions 28 are arranged in the up-down direction. One row and the other row are different in position in the left-right direction.

In the following description, the insertion-receiving portions 28 included in the left row of the above-described two rows are also referred to as first insertion-receiving portions 28A. Further, the insertion-receiving portions 28 included in the right row of the above-described two rows are also referred to as second insertion-receiving portions 28B.

The plurality of release operating elements 32 are accommodated in the housing 16a. However, a part of each release operating element 32 is exposed to the outside of the housing 16a at the front portion 10F so that the operator can operate the release operating element 32. Further, the plurality of release operating elements 32 (32A, 32B) include a plurality of first release operating elements 32A and a plurality of second release operating elements 32B.

The plurality of first release operating elements 32A are disposed corresponding to the plurality of first insertion-receiving portions 28A, respectively. In the illustration of FIGS. 4A and 4B, each first release operating element 32A is disposed on the left side of the corresponding first insertion-receiving portion 28A. Further, the first release operating elements 32A are arranged in the up-down direction.

The plurality of second release operating elements 32B are disposed corresponding to the plurality of second insertion-receiving portions 28B, respectively. In the illustration of FIGS. 4A and 4B, each second release operating element 32B is disposed on the right side of the corresponding second insertion-receiving portion 28B. Further, the plurality of second release operating elements 32B are arranged in the up-down direction.

The plurality of lighting portions 34 (34A, 34B) include a plurality of first lighting portions 34A and a plurality of second lighting portions 34B.

The plurality of first lighting portions 34A are disposed corresponding to the plurality of first insertion-receiving portions 28A, respectively. In the illustration of FIGS. 4A and 4B, each first lighting portion 34A is disposed on the left side of the corresponding first insertion-receiving portion 28A. Further, the plurality of first lighting portions 34A are arranged in the up-down direction.

The plurality of second lighting portions 34B are disposed corresponding to the plurality of second insertion-receiving portions 28B, respectively. In the illustration of FIGS. 4A and 4B, each second lighting portion 34B is disposed on the right side of the corresponding second insertion-receiving portion 28B. Further, the second lighting portions 34B are arranged in the up-down direction.

FIG. 5 is a diagram for explaining the internal configuration of the connector unit 16 according to the embodiment.

The connector unit 16 further includes a plurality of light guide members 36 and a plurality of coupling members 38.

The plurality of light guide members 36 and the plurality of coupling members 38 are accommodated in the housing 16a. However, at least a portion of each of the plurality of light guide members 36 and at least a portion of each of the plurality of coupling members 38 may protrude rearward from the housing 16a. In this case, the portions of the plurality of light guide members 36 and the portions of the plurality of coupling members 38 that protrude rearward from the housing 16a may be accommodated in the housing 14a of the communication processing unit 14 by the connector unit 16 being mounted on the communication processing unit 14.

Each of the plurality of light guide members 36 is long in the front-rear direction. Further, each light guide member 36 includes a first end portion 42 and a second end portion 44. The first end portion 42 is a tip portion of the light guide member 36 on the front side. The second end portion 44 is a tip portion of the light guide member 36 on the rear side.

The first end portions 42 of the plurality of light guide members 36 are connected to the different lighting portions 34. Further, the second end portions 44 of the plurality of light guide members 36 are connected to the different light emitting elements 24 by the connector unit 16 being mounted on the communication processing unit 14.

Each light guide member 36 guides light emitted by the corresponding light emitting element 24 to the corresponding lighting portion 34. As a result, the plurality of lighting portions 34 are lit in response to the light emission of the plurality of light emitting elements 24.

According to the embodiment, the plurality of light guide members 36 (36A, 36B) include the light guide member 36 connected to the first lighting portion 34A, and the light guide member 36 connected to the second lighting portion 34B. In view of this, the light guide member 36 connected to the first lighting portion 34A is also referred to as a first light guide member 36A in the following description. Further, the light guide member 36 connected to the second lighting portion 34B is also referred to as a second light guide member 36B in the following description.

Each of the plurality of coupling members 38 is a linear (columnar) member that is long in the up-down direction. Each of the coupling members 38 couples together the plurality of light guide members 36. In this instance, the plurality of coupling members 38 (38A, 38B) include a plurality of first coupling members 38A, and a plurality of second coupling members 38B.

Each of the plurality of first coupling members 38A couples together the plurality of first light guide members 36A. The plurality of first light guide members 36A and the plurality of first coupling members 38A may be integrally formed.

Each of the plurality of second coupling members 38B couples together the plurality of second light guide members 36B. The plurality of second light guide members 36B and the plurality of second coupling members 38B may be integrally formed.

The number of times of insertion operation required for the operator to accommodate the plurality of coupled light guide members 36 in the housing 16a is only one. That is, according to the present embodiment, the operator does not need to repeat the operation of accommodating the plurality of light guide members 36 in the housing 16a the same number of times as the number of the light guide members 36. Therefore, the operator can easily and quickly perform the assembly operation of the I/O unit 10.

In this manner, according to the present embodiment, an increase in the operating time for assembling the plurality of light guide members 36 to the I/O unit 10 is suppressed.

Each coupling member 38 is preferably made of the same material as the light guide member 36. This suppresses an increase in the number of types of materials included in the connector unit 16.

Note that, in a case where the coupling member 38 is made of the same material as the light guide member 36, there is a possibility that light leaks from the light guide member 36 to the coupling member 38. The light leaking from the light guide member 36 to the coupling member 38 may reduce the amount of light of the lighting portion 34 corresponding to that light guide member 36.

In view of this, it is preferable that the connection locations of the plurality of coupling members 38 with the light guide members 36 and the shapes of the light guide members 36 are designed in consideration of the characteristics of the material related to the reflection angle of light. This can minimize the possibility that light leaks from the light guide member 36 to the coupling member 38.

Moreover, according to the present embodiment, the I/O unit 10 can be divided into a plurality of units. Specifically, the I/O unit 10 can be divided into the connector unit 16 having a function of connecting to the device 104, the communication processing unit 14 having a function of performing communication processing, and the base unit 12 having a function of connecting to another I/O unit 10. As a result, the operator can perform maintenance on each of the connector unit 16, the communication processing unit 14, and the base unit 12, for example.

### Modifications

Modifications of the above-described embodiment will be described below. However, explanations overlapping with those of the above-described embodiment will be omitted as much as possible in the following description. Elements that have been described in the above-described embodiment are denoted by the same reference numerals as in the above-described embodiment unless otherwise specified.

### (Modification 1)

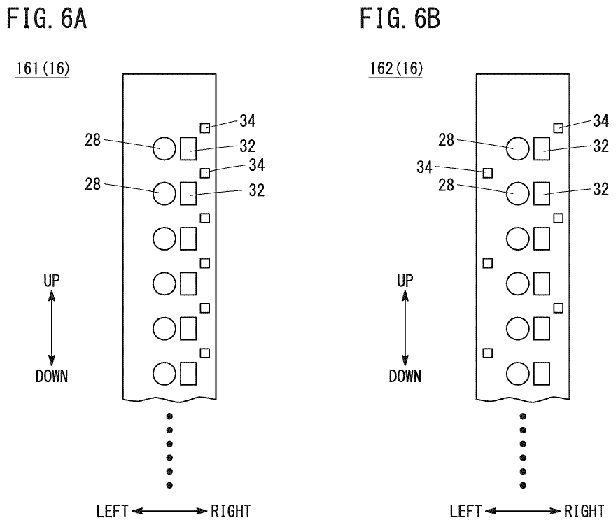

FIG. 6A is a diagram showing a connector unit 161 (16) according to a first modification. FIG. 6B is a diagram showing another connector unit 162 (16) according to the first modification.

All the insertion-receiving portions 28 may be arranged in a line (FIGS. 6A and 6B). Similarly, all the lighting portions 34 may be arranged in a line.

The plurality of lighting portions 34 may be disposed on the right side or the left side of the plurality of insertion-receiving portions 28 arranged in a line. The lighting portions 34 disposed on the right side of the plurality of insertion-receiving portions 28 and the lighting portions 34 disposed on the left side of the plurality of insertion-receiving portions 28 may be mixed.

### (Modification 2)

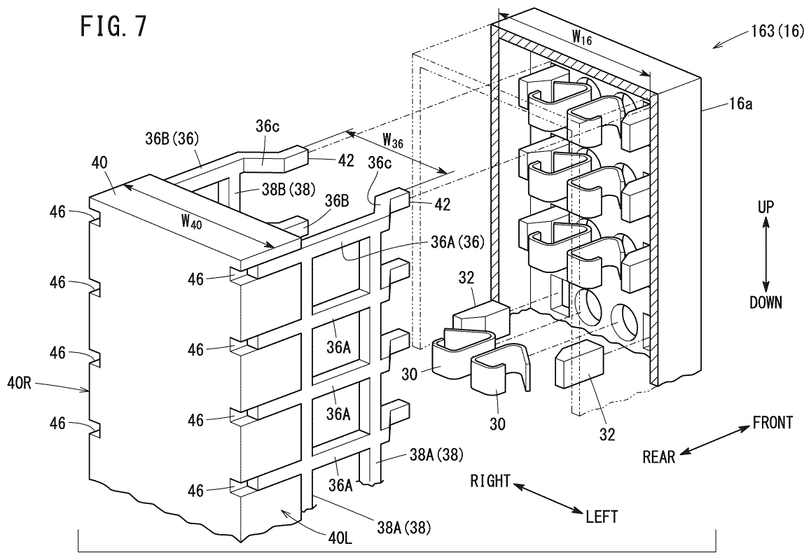

FIG. 7 is a diagram showing a connector unit 163 (16) according to a second modification.

The connector unit 163 includes the components of the connector unit 16 (see the embodiment). The connector unit 163 further includes an attachment member 40.

The attachment member 40 has a size that can be accommodated inside the housing 16a. For example, a width W₄₀ of the attachment member 40 is smaller than a width W₁₆ of the inner side of the housing 16a in the left-right direction (W₄₀<W₁₆).

Further, a plurality of attachment portions 46 are formed in the attachment member 40. Each attachment portion 46 is formed for attaching the light guide member 36 to the attachment member 40. Each attachment portion 46 includes, for example, a groove portion capable of holding the light guide member 36.

The plurality of attachment portions 46 are formed at a left end portion 40L and a right end portion 40R of the attachment member 40. The plurality of attachment portions 46 formed at the left end portion 40L hold the plurality of first light guide members 36A. The plurality of attachment portions 46 formed at the right end portion 40R hold the plurality of second light guide members 36B.

The plurality of light guide members 36 attached to the attachment member 40 protrude forward from the attachment member 40.

The operator accommodates, in the housing 16a, the attachment member 40 to which the plurality of light guide members 36 are attached. Consequently, the operator can collectively accommodate all the light guide members 36 in the housing 16a by one operation of accommodating the attachment member 40 in the housing 16a.

At least a portion of the attachment member 40 may protrude rearward from the housing 16a. In this case, the portion of the attachment member 40 that protrudes rearward from the housing 16a may be accommodated in the housing 14a of the communication processing unit 14 by the connector unit 16 being mounted on the communication processing unit 14.

When the attachment member 40 is employed, it is more preferable that each of the plurality of light guide members 36 includes a bent portion 36c. The bent portion 36c of each light guide member 36 is located forward of the attachment member 40 in a state where the light guide member 36 is attached to the attachment member 40.

Each light guide member 36 is bent in a substantially crank shape at the bent portion 36c. The first end portion 42 of each light guide member 36 faces forward in front of the bent portion 36c.

The way of bending at the bent portion 36c is different between the first light guide member 36A and the second light guide member 36B. Specifically, each first light guide member 36A is bent toward the second light guide member 36B (rightward) at the bent portion 36c. On the other hand, each second light guide member 36B is bent toward the first light guide member 36A (leftward) at the bent portion 36c.

Accordingly, an interval W₃₅ between the first end portion 42 of the first light guide member 36A and the first end portion 42 of the second light guide member 36B in the left-right direction becomes smaller than the width W₄₀ of the attachment member 40 (W₃₆<W₄₀). Consequently, the interval W₃₆ between the first end portion 42 of the first light guide member 36A and the first end portion 42 of the second light guide member 36B in the left-right direction can be made sufficiently smaller than the width W₁₆ of the inner side of the housing 16a (W₃₆<W₁₆). As a result, the assembly operation of the connector unit 16 is facilitated.

Specifically, the operator attaches the plurality of light guide members 36 to the above-described attachment member 40 in the assembly operation of the connector unit 16. Next, the operator accommodates the attachment member 40 in the housing 16a toward the front side from the rear of the housing 16a.

Here, since the interval W₃₆ is sufficiently smaller than the width W₁₆, the operator can easily insert the first end portions 42 of the first light guide members 36A and the first end portions 42 of the second light guide members 36B into the inside of the housing 16a.

### (Modification 3)

The number of the first coupling members 38A for coupling the plurality of first light guide members 36A may be one. Similarly, the number of the second coupling members 38B for coupling the plurality of second light guide members 36B may be one.

### (Modification 4)

The first end portion 42 of each light guide member 36 and the lighting portion 34 corresponding to the light guide member 36 may be integrally formed.

### (Combination of Plurality of Modifications)

The modifications described above may be appropriately combined within a range in which no contradiction occurs.

### Inventions Obtained from Embodiment

Hereinafter, the inventions that can be grasped from the above-described embodiment and modifications will be described.

### First Aspect of Invention

A first aspect of the present invention is the terminal block (16) including: the plurality of insertion-receiving portions (28) into which the plurality of external terminals (104a) are inserted, respectively, and which are provided respectively with the connection terminals (30) each electrically connected to a corresponding one of the inserted external terminals; the plurality of lighting portions (34) provided corresponding to the plurality of insertion-receiving portions, respectively; the plurality of light guide members (36) provided corresponding to the plurality of lighting portions, respectively, and each configured to light a corresponding one of the plurality of lighting portions by guiding, to the corresponding one of the plurality of lighting portions, light emitted by a corresponding one of the plurality of light emitting elements (24); and at least one coupling member (38) coupling the plurality of light guide members.

This suppresses an increase in the operating time for assembling the light guide members to the terminal block.

The plurality of insertion-receiving portions may be provided so as to be arranged along a first direction, and the plurality of light guide members may be provided so as to be arranged along the first direction at positions that are different from positions of the plurality of insertion-receiving portions in a second direction orthogonal to the first direction.

The plurality of insertion-receiving portions may include the plurality of first insertion-receiving portions (28A) arranged along the first direction, and the plurality of second insertion-receiving portions (28B) arranged along the first direction at positions that are different from positions of the plurality of first insertion-receiving portions in the second direction.

The plurality of light guide members may include the plurality of first light guide members (36A) provided on one side of the plurality of insertion-receiving portions in the second direction, and the plurality of second light guide members (36B) provided on the other side of the plurality of insertion-receiving portions in the second direction, and the coupling member may include at least one first coupling member (38A) coupling the plurality of first light guide members, and at least one second coupling member (38B) coupling the plurality of second light guide members.

The first aspect of the present invention may further include the attachment member (40), the plurality of first light guide members being attached to the attachment member on one side in the second direction and the plurality of second light guide members being attached to the attachment member on the other side in the second direction, and the housing (16a) configured to accommodate the plurality of first light guide members and the plurality of second light guide members together with the attachment member, the plurality of first light guide members and the plurality of second light guide members may protrude from the attachment member in the direction toward which the first light guide members and the second light guide members are accommodated in the housing, each of the plurality of first light guide members may be bent toward the other side in the second direction, and each of the plurality of second light guide members may be bent toward the one side in the second direction. This improves the ease of assembly.

The at least one coupling member and the plurality of light guide members may contain the same material. This enables the plurality of coupling members and the plurality of light guide members to be integrally manufactured in the same manufacturing process.

### Second Aspect of Invention

A second aspect of the present invention is the I/O unit (10) including the terminal block according to the first aspect, and the I/O unit includes the plurality of light emitting elements, and the communication processing circuit (22) configured to control input/output of the signals to/from the plurality of external terminals connected to the terminal block, and control light emission of the plurality of light emitting elements.

This suppresses an increase in the operating time for assembling the light guide members to the I/O unit.

### REFERENCE SIGNS LIST

10: I/O unit
16, 161 to 163: connector unit (terminal block)
16a: housing
22: communication processing circuit
24: light emitting element
26: control module
28: insertion-receiving portion
30: connection terminal
34: lighting portion
36: light guide member
38: coupling member
40: attachment member
104a: external terminal

1. A terminal block comprising:
a plurality of insertion-receiving portions into which a plurality of external terminals are inserted, respectively, and which are provided respectively with connection terminals each electrically connected to a corresponding one of the inserted external terminals;
a plurality of lighting portions provided corresponding to the plurality of insertion-receiving portions, respectively;
a plurality of light guide members provided corresponding to the plurality of lighting portions, respectively, and each configured to light a corresponding one of the plurality of lighting portions by guiding, to the corresponding one of the plurality of lighting portions, light emitted by a corresponding one of a plurality of light emitting elements; and
at least one coupling member coupling the plurality of light guide members.

2. The terminal block according to claim 1, wherein
the plurality of insertion-receiving portions are provided so as to be arranged along a first direction, and
the plurality of light guide members are provided so as to be arranged along the first direction at positions that are different from positions of the plurality of insertion-receiving portions in a second direction orthogonal to the first direction.

3. The terminal block according to claim 2, wherein
the plurality of insertion-receiving portions include:
a plurality of first insertion-receiving portions arranged along the first direction; and
a plurality of second insertion-receiving portions arranged along the first direction at positions that are different from positions of the plurality of first insertion-receiving portions in the second direction.

4. The terminal block according to claim 2, wherein
the plurality of light guide members include:
a plurality of first light guide members provided on one side of the plurality of insertion-receiving portions in the second direction; and
a plurality of second light guide members provided on another side of the plurality of insertion-receiving portions in the second direction, and
the coupling member includes:
at least one first coupling member coupling the plurality of first light guide members; and
at least one second coupling member coupling the plurality of second light guide members.

5. The terminal block according to claim 4, further comprising:
an attachment member, the plurality of first light guide members being attached to the attachment member on one side in the second direction and the plurality of second light guide members being attached to the attachment member on another side in the second direction; and
a housing configured to accommodate the plurality of first light guide members and the plurality of second light guide members together with the attachment member, wherein
the plurality of first light guide members and the plurality of second light guide members protrude from the attachment member in a direction toward which the first light guide members and the second light guide members are accommodated in the housing, and
each of the plurality of first light guide members is bent toward the other side in the second direction, and each of the plurality of second light guide members is bent toward the one side in the second direction.

6. The terminal block according to claim 1, wherein
the at least one coupling member and the plurality of light guide members contain a same material.

7. An I/O unit comprising:
the terminal block according to claim 1;
the plurality of light emitting elements; and
a communication processing circuit configured to control input/output of signals to/from the plurality of external terminals connected to the terminal block, and control light emission of the plurality of light emitting elements.
